(19) United States
(12) Patent Application Publication
(10) Pub. No.: US 2008/0170811 A1
(43) Pub. Date: Jul. 17, 2008

(54) IMAGE CAPTURE APPARATUS

(75) Inventors: Chih-Ho Hsieh, Taipei City (TW); Tung-Ho Tsai, Taipei City (TW); Chao-Yi Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PROLIFIC TECHNOLOGY INC., Taipei (TW)

(21) Appl. No.: 11/964,050

(22) Filed: Dec. 26, 2007

(30) Foreign Application Priority Data
Jan. 12, 2007 (TW) 96101252

(51) Int. Cl. G06T 1/00

(52) U.S. Cl. 382/305

(57) ABSTRACT

An image capture apparatus is provided. The apparatus includes an image capture, a memory unit, a sampling unit, and an image coder. The image capture captures a plurality of image data. The memory unit is coupled to the image capture and stores the image data output by the image capture. The sampling unit is coupled to the memory unit to sample the stored image data and outputs a sampling image data. The image coder is coupled to the sampling unit to code and compress the sampling image data.

### CROSS-REFERENCE TO RELATED APPLICATION

This application claims the priority benefit of Taiwan application serial no. 96101252, filed on Jan. 12, 2007. The entirety of the above-mentioned patent application is hereby incorporated by reference herein and made a part of this specification.

### BACKGROUND OF THE INVENTION

1. Field of the Invention

The present invention relates to an image capture apparatus. More particularly, the present invention relates to an image capture apparatus capable of adjusting different resolutions.

2. Description of Related Art

In a conventional image monitoring system, the resolution of an image capture apparatus is generally fixed. A conventional image capture apparatus usually only has an image capture and an image coding compressing coder. As the image data captured by the image capture is fixed, the image coding compressing unit can only compress and output an image with a single resolution. It is impossible to provide suitable image data for systems with different bandwidths. When the bandwidth of a system is small, the image data with a high resolution results in the burden on the transmission of the system. In addition, for application of different occasions, it is impossible to provide the function of adjusting the resolution, thus reducing the convenience on usage.

In the conventional art, when it is necessary to output images with different resolutions, usually a plurality of image captures and a plurality of image coders are used to capture and compress the images with different resolutions. However, the cost of such a system is obviously very high. Recently, the development of the monitoring system is diversified, for example, being applied to IP cam/security cam, video transcoder system, mobile phone, TV set, computer, and even car navigation system. Therefore, in order to achieve the optimal image transmission effect, the image capture apparatus with a single resolution apparently cannot meet the demand of a user.

### SUMMARY OF THE INVENTION

Accordingly, the present invention is directed to provide an image capture apparatus, which can adjust and output image data with different resolutions according to different sample rates.

The present invention is also directed to provide an image capture apparatus, which uses a storage medium to store the captured image data. Only one time of capturing is required, and image compressed data with different resolutions are generated by adjusting the sample rates.

The present invention is further directed to provide a method of capturing an image. According to different operating requirements, the image date is first sampled by different sample rates. Then, the image coding is performed to output image data with different resolutions.

As embodied and broadly described herein, the present invention provides an image capture apparatus, which includes an image capture, a memory unit, a sampling unit, and an image coder. The image capture is used to capture a plurality of image data. The memory unit is coupled to the image capture, for storing the image data captured by the image capture. The sampling unit is coupled to the memory unit, for sampling the stored image date, and outputting the sampling image data accordingly. The image coder is coupled to the sampling unit, for coding and compressing the sampling image data.

In an embodiment of the present invention, the sampling unit may adjust the rate of sampling the image data according to a control signal.

From another point of view, the present invention provides a method of capturing an image, which includes the following steps. First, a plurality of image data is captured. Next, the captured image data is stored. Then, the stored image data is sampled, and the sampling image data is output. Afterward, the sampling image data is coded and compressed.

In the present invention, the sampling unit is used to sample the image data captured by the image capture, and then the image data is coded and compressed. Therefore, only an image capture and an image coder are used to adjust and output image data with different resolutions. Meanwhile, as the image data stored in the storage medium can be repeatedly used, only one time of capturing is required, and image compressed data with different resolutions is generated by adjusting the sample rate. The cost of the image capture apparatus is reduced significantly, and the image capture can achieve the optimal transmission effect in different application environments.

In order to make the aforementioned and other objectives, features, and advantages of the present invention comprehensible, preferred embodiments accompanied with figures are described in detail below.

### BRIEF DESCRIPTION OF THE DRAWINGS

FIG. 1 is a block diagram of an image capture apparatus according to an embodiment of the present invention.

FIG. 2 is a block diagram of the image capture apparatus according to another embodiment of the present invention.

FIG. 3 is a flow chart of a method of capturing an image according to another embodiment of the present invention.

### DESCRIPTION OF EMBODIMENTS

An image capture can be used to capture image data, and is quite widely utilized, for example, applied to video camera, digital camera, TV box, web camera, IP cam/security cam, Wi-Fi media pump, and so on. A digital image signal can be directly captured from an entity image (such as a scenery and animal), or directly converted from an analog or digital signal (such as a TV image signal). Any image capture capable of capturing image data is applicable to the image capture apparatus of the present invention.

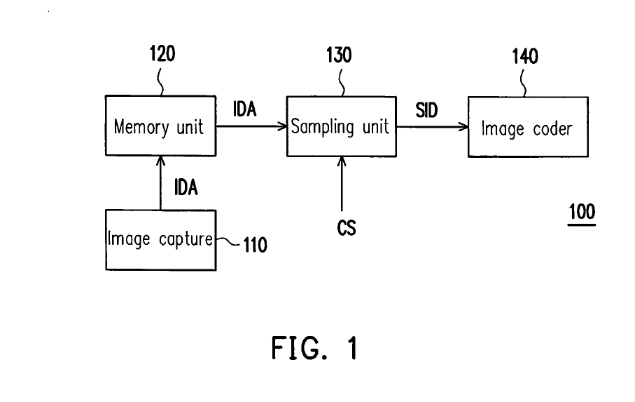

Next, an embodiment is used to illustrate the main technical means of the present invention. FIG. 1 is a block diagram of an image capture apparatus according to an embodiment of the present invention. The image capture apparatus 100 includes an image capture 110, a memory unit 120, a sampling unit 130, and an image coder 140. The memory unit 120 is coupled to the image capture 110 and the sampling unit 130. The image coder 140 is coupled to the sampling unit 130.

The image capture 110 can directly capture an image data IDA from an entity image or a digital signal. In this embodiment, the image data IDA can be consecutively captured, for example, the data of a plurality of image frames is consecutively captured or the data of an image frame is captured at an interval of a predetermined time. Then, the image capture 110 stores the captured image data IDA into the memory unit 120. In this embodiment, the memory unit 120 is a storage medium for storing data, such as hard disk, optical disk, flash memory, or DRAM, DDR. Any storage medium with data storage function can be applied in this embodiment.

The sampling unit 130 reads the required image data IDA from the memory unit 120. After sampling, a sampling image data SID is output to the image coder 140. The image coder 140 performs coding and compressing on the received sampling image data SID, and outputs an image compressed data with different resolutions according to the sample rate of the sampling unit 130. As the transmission bandwidths required by the image compressed data with different resolutions (for example, images with 800×600 pixels, 24 frames per second, or of VGA level, 60 frames per second) are different, in this embodiment, the sample rate of the sampling unit 130 can be adjusted according to the system bandwidth or the requirements of the users, such that the image coder 140 outputs the image compressed data with different resolutions, thereby achieving the optimal transmission effect. The image data IDA stored in the memory unit 120 can be repeatedly used, and the same frame only needs to be captured once. The image compressed data with different resolutions can be generated by adjusted the sample rate of the sampling unit 130. Therefore, the convenience and functionality of the image capture apparatus 100 are greatly enhanced.

In this embodiment, the sampling unit 130 has a plurality of sampling modes. Each of the sampling modes has different sample rates (such as 1, ¼, and 1/16). The sampling mode of ¼ is taken as an example, which indicates that the sampling unit 130 will sample every four image data IDA in the memory unit 120, and then form a sampling image data SID. The sample rate of 1/16 indicates that the sampling unit 130 will sample sixteen image data IDA in the memory unit 120, and then form a sampling image data SID. The sampling of the image data IDA of the memory unit 120 to form the sampling image data SID is repeatedly performed, and then the image coder 140 is used for coding and compressing to output corresponding image compressed data ICD.

The sample rate of the sampling unit 130 is controlled by a control signal CS, and the control signal CS can be generated by the system or by a software program. In this manner, the user may adjust the sample rate of the sampling unit 130 according to the required image resolution, or the system (such as the monitoring system) automatically adjusts the suitable sample rate to achieve the optimal transmission effect. In another embodiment of the present invention, if it is not necessary for the image capture apparatus 100 to adjust the resolution, the sampling unit 130 is disabled by the control signal CS. When the sampling unit 130 is in a disabled state or is not activated, the image coder 140 directly codes and compresses the image data IDA in the memory 120. In other words, the sampling image data SID received by the image coder 140 is equal to the image data IDA, i.e. the un-sampled image data IDA.

As for the structure of the sampling unit 130, the sampling unit 130 may be constituted by a logic circuit or a microprocessor, or realized by programming through the operation function of the system. Those of ordinary skill in the art may easily figure out other implementing methods of the sampling unit and the control signal through the disclosure of the present invention, and the details will not be described herein again.

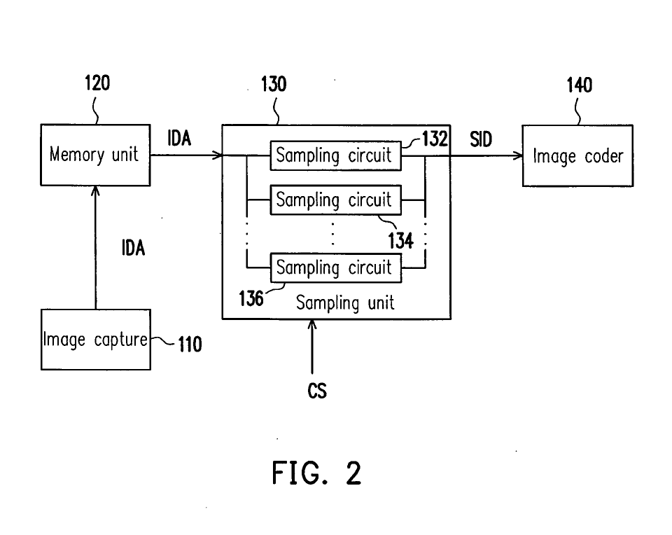

In another embodiment of the present invention, referring to FIG. 2, a block diagram of the image capture apparatus according to another embodiment of the present invention is shown. The main difference between the embodiments of FIGS. 1 and 2 lies in the sampling unit 130. In FIG. 2, the sampling unit 130 includes a plurality of sampling circuits 132-136. Each of the sampling circuits 132-136 has different sample rates (such as 1, ¼, and 1/16). The sample unit 130 determines to enable one of the sampling circuits 132-136 (for example, the sampling circuit 132) according to the control signal CS. The sampling circuit 132 samples every four image data IDA in the memory unit 120 according to the corresponding sample rate (for example, ¼), and then forms a sampling image data SID. The rest may be deduced by analogy, and the details will not be described herein again.

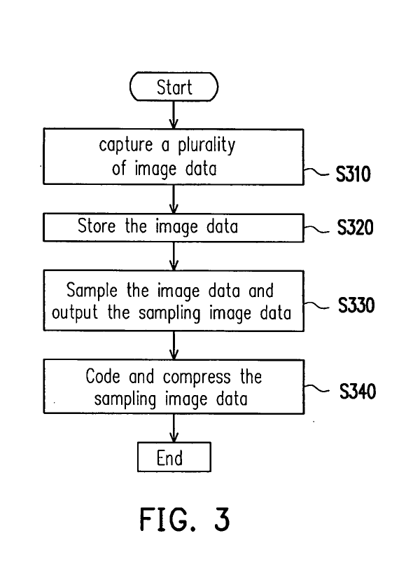

From another point of view, the present invention also provides a method of capturing an image. Referring to FIGS. 1 and 3, FIG. 3 is a flow chart of a method of capturing an image according to another embodiment of the present invention. First, in Step S310, a plurality of image data is captured. Next, in Step S320, the captured image data is stored. Then, in Step S330, the stored image data is sampled, and a sampling image data is output. In the above step, the sample rate of the image data is adjusted (for example, 1, ¼, or 1/16) according to a control signal. Afterward, in Step S340, the obtained sampling image data is coded and compressed. The relative implementing details of the method of capturing an image of this embodiment can refer to the illustration of the embodiments in FIGS. 1 and 2. Those of ordinary skill in the art may easily figure out the relative implementing details through the disclosure of the present invention, and the details will not be described herein again.

In the present invention, the sampling technique is applied to the image capture apparatus, in which a single image capture and a single image coder are used to output image data with different resolutions. Meanwhile, as the stored image data can be repeatedly used, only one time of capturing is required to generate image compressed data with different resolutions. Therefore, the design cost is significantly reduced, and the convenience of the image capture apparatus is also enhanced.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. An image capture apparatus, comprising:
an image capture, for capturing a plurality of image data;
a memory unit, coupled to the image capture, for storing the image data;
a sampling unit, coupled to the memory unit, for sampling the stored image data and outputting a sampling image data; and
an image coder, coupled to the sampling unit, for coding and compressing the sampling image data.

2. The image capture apparatus as claimed in claim 1, wherein the sampling unit has a plurality of sampling modes, and each of the sampling modes has a different sample rate.

3. The image capture apparatus as claimed in claim 2, wherein the sample rate of a first sampling mode of the sampling modes is ¼.

4. The image capture apparatus as claimed in claim 2, wherein the sample rate of a second sampling mode of the sampling modes is 1/16.

5. The image capture apparatus as claimed in claim 2, wherein the sample rate of a third sampling mode of the sampling modes is 1.

6. The image capture apparatus as claimed in claim 1, wherein if the sampling unit is in a disabled state, the sampling image data is equal to one of the image data.

7. The image capture apparatus as claimed in claim 1, wherein the sampling unit is a logic circuit.

8. The image capture apparatus as claimed in claim 1, wherein the sampling unit is a micro-processor.

9. The image capture apparatus as claimed in claim 1, wherein the sampling unit determines the sample rate of the sampling unit according to a control signal.

10. The image capture apparatus as claimed in claim 1, wherein the sampling unit comprises a plurality of sampling circuits, each of the sampling circuits has a different sample rate, and the sampling unit enables one of the sampling circuits according to a control signal.

11. The image capture apparatus as claimed in claim 1, wherein the image capture comprises a video camera.

12. A method for capturing an image, comprising:
capturing a plurality of image data;
storing the image data;
sampling the stored image data, and outputting a sampling image data; and
coding and compressing the sampling image data.

13. The method for capturing an image as claimed in claim 12, wherein in the step of sampling the image data, the sample rate of the image data is adjusted according to a control signal.

14. The method for capturing an image as claimed in claim 13, wherein the sample rate is ¼.

15. The method for capturing an image as claimed in claim 12, wherein the sample rate is 1/16.

16. The method for capturing an image as claimed in claim 12, wherein the sample rate is 1.
